(19) United States
(12) Patent Application Publication
(10) Pub. No.: US 2018/0237259 A1
(43) Pub. Date: Aug. 23, 2018

(54) METHOD FOR DETECTING TRAPPED PASSENGERS IN ELEVATOR CAR

(71) Applicant: Otis Elevator Company, Farmington, CT (US)

(72) Inventors: Hiromitsu Miyajima, Inzai (JP); Daisuke Meguro, Tokyo (JP)

(21) Appl. No.: 15/438,900

(22) Filed: Feb. 22, 2017

(51) Int. Cl. B66B 5/00; B66B 5/02; B66B 3/00

(52) U.S. Cl. CPC B66B 5/0012; B66B 3/002; B66B 5/02

(57) ABSTRACT

A method for detecting trapped passengers in an elevator car (1) comprises collecting a sound in the elevator car (1) when an elevator controller (2) detects any failure of an elevator and comparing the level of the sound a threshold level. The method further includes automatically making a call to a help desk (26) and taking pictures in the interior of the elevator car (1) when the level of the sound exceeds the threshold level.

### BACKGROUND OF THE INVENTION

The present invention generally relates to an elevator system, and more particularly to a method for detecting trapped passengers in an elevator car.

Elevator systems are widely known and used in various places. The elevator system includes an elevator car that moves between landings in a building to transport passengers between different building levels. The elevator car is provided with a car operating panel which includes a car door open button, a car door close button and destination floor buttons, etc. Along with these buttons, the car operating panel includes an emergency button and an intercom such that a passenger can make an emergency call to a help desk by pressing the emergency button when the passenger is trapped in the elevator car due to the failure of the elevator system or disasters such as earthquakes, for example.

However, with the conventional elevator system, the emergency stop button is usually placed on the upper part of the car operating panel; therefore, passengers such as children or ones who use wheelchairs may not reach to the emergency stop button. Accordingly, such trapped passengers may not make an emergency call to the help desk so that operators in the help desk may not notice the trapped passengers.

### SUMMARY OF THE INVENTION

According to one embodiment of the invention, a method for detecting trapped passengers in an elevator car is provided. The method comprises collecting a sound in the interior of the elevator car when any failure of an elevator is detected; comparing the level of the sound with a threshold level; and determining that there is a trapped passenger in the elevator car when the level of the sound exceeds the threshold level.

According to another embodiment of the invention, the method further comprises automatically making a call to a help desk when the level of the sound exceeds the threshold level.

According to yet another embodiment of the invention, the method further comprises taking pictures of the interior of the elevator car and outputting picture images to the help desk.

According to another embodiment of the invention, an elevator system is provided. The elevator system comprises an elevator controller controlling the movement of an elevator car and detecting a failure of an elevator; an alarming unit providing a communication network between an elevator car and a help desk remote from the elevator and receiving a failure signal output from the elevator controller; and an analyzer unit collecting a sound in the interior of the elevator car. The analyzer unit compares the level of the sound with a threshold level and outputs a result to the alarming unit.

According to another embodiment of the invention, the analyzer unit automatically makes a call to a help desk when the level of the sound exceeds the threshold level.

According to another embodiment of the invention, the system further comprises a camera provided within an elevator car and wherein the camera takes pictures of the interior of the elevator car when the level of the sound exceeds the threshold level.

According to yet another embodiment of the invention, the system further comprises an intercom through which the sound in the interior of the elevator car is collected.

The foregoing and other objects, features and advantages of the present invention become more apparent in light of the following detailed description of the exemplary embodiments thereof, as illustrated in the accompanying drawings.

### BRIEF DESCRIPTION OF THE DRAWINGS

FIG. 1 shows selected portions of an elevator car according to an embodiment of the invention.

FIG. 2 shows a sound trigger alarming system according to an embodiment of the invention.

FIG. 3 is a flowchart showing a procedure for detecting trapped passengers in the elevator car according to an embodiment of the invention.

### DETAILED DESCRIPTION

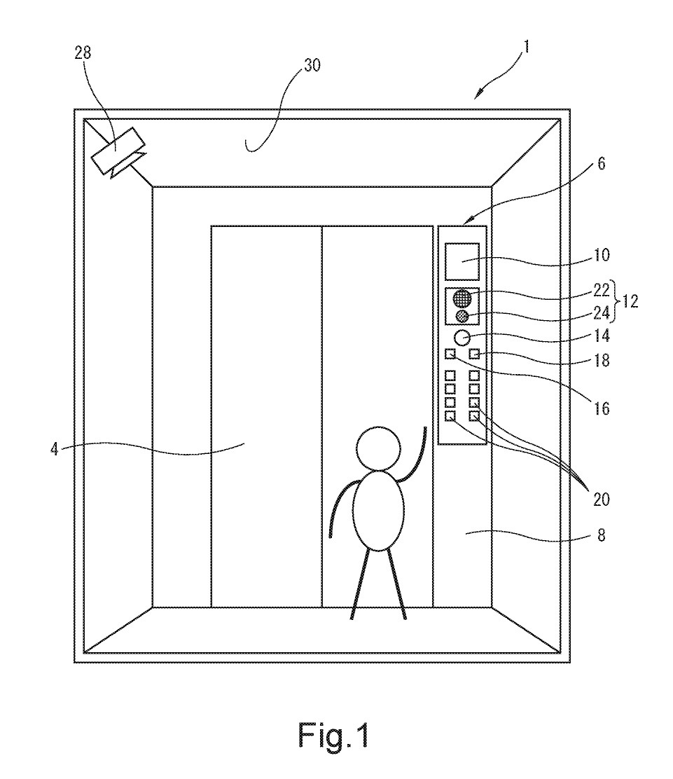

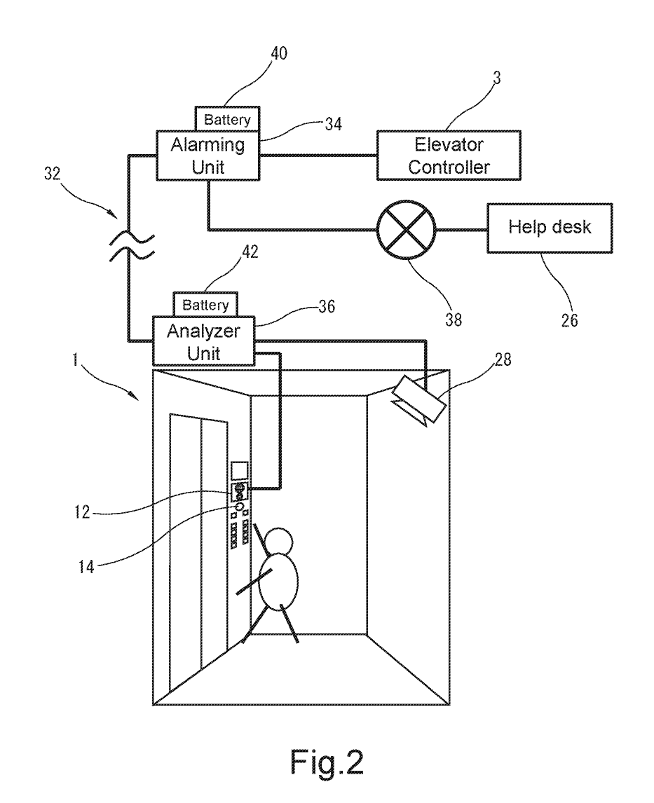

An elevator system includes an elevator car 1 movable within a hoistway (not shown) to provide elevator service to a plurality of landings, and an elevator controller 2 (see FIG. 2) which controls the movement of the elevator car 1 and detects the failure of an elevator. The elevator controller 2 is disposed in a machine room (not shown) which is built above the hoistway. As shown in FIG. 1, the elevator car 1 includes car doors 4 configured to move along the entrance of the elevator car 1 to open and close the entrance. Further, the elevator car 1 includes a car operating panel 6 provided on a wall portion 8 which is located on one side of the car doors 4. In this embodiment, the car operating panel 6 includes, from top to bottom, a car position indicator 10, an intercom 12, an emergency button 14, a car door open button 16, a car door close button 18 and destination floor buttons 20. The car position indicator 10 shows the current position and the direction of the elevator car 1. The car door open button 16 and the car door close button 18 are used to open and close the car doors 4, respectively. The destination floor buttons 20 allow passengers to select desired destination floors.

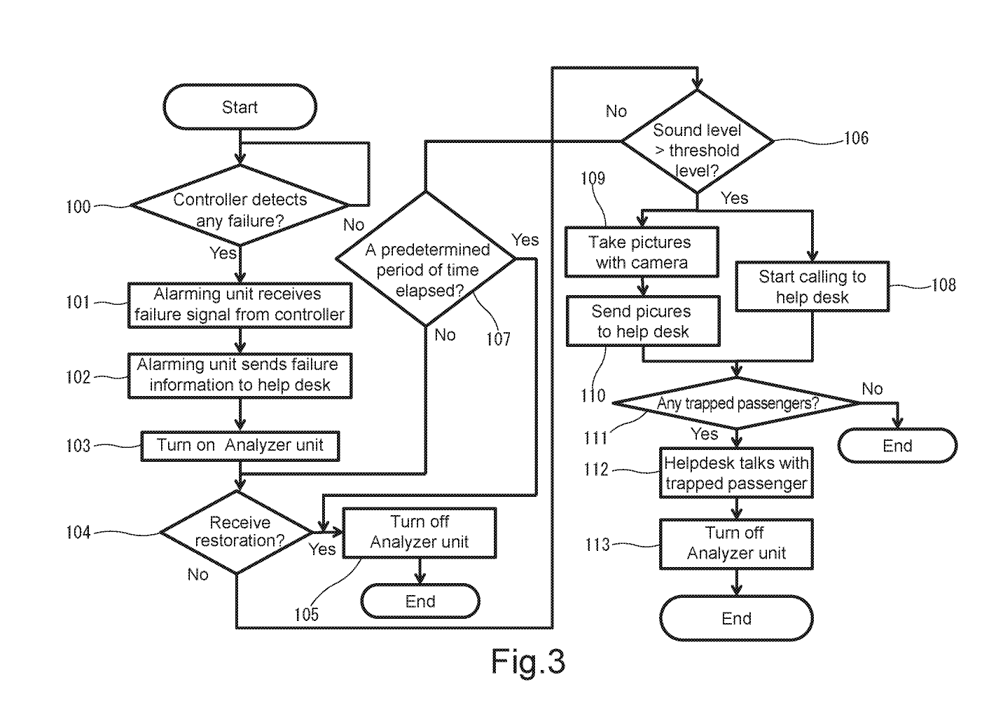

The intercom 12 includes a speaker 22 and a microphone 24 which allow passengers to communicate with an operator in a help desk 26 (see FIG. 3) located remote from the building. The emergency button 14 is used to give an alarm to the help desk 26 and to activate the intercom 12 when passengers are in trouble, for example, trapped in the elevator car 1. In this embodiment, the position of the emergency button 14 is too high for passengers such as small children to reach the emergency button 14.

In addition, the elevator car 1 includes a camera 28 which is disposed on a ceiling 30 of the elevator car 1 to take pictures of the interior of the elevator car 1 and passengers if any. The camera 28 may be an analog camera, a digital camera, a TOF (Time of Flight) camera or an infrared light camera, etc.

FIG. 2 shows a sound trigger alarming system 32 which is used in conjunction with the elevator car 1. The sound trigger alarming system 32 comprises the intercom 12, the camera 28, an alarming unit 34 and an analyzer unit 36.

The alarming unit 34 is located in the machine room and provides a communication network between the elevator car 1 and the help desk 26. The alarming unit 34 is connected to the elevator controller 2 and receives a failure signal which is transmitted from the elevator controller 2 when the elevator controller 2 detects any failure of the elevator system. The alarming unit 34 is also connected to the help desk 26 via a network 38 such as a telephone line, a VoIP network, the Internet, etc. The alarming unit 34 makes an alert message and sends failure information to the help desk 26 via the network 38 when the alarming unit 34 receives the failure signal from the controller 2. Not shown in the FIG. 2, the alarming unit 34 also receives an input signal from the emergency button 14. The alarming unit 34 includes a battery 40 so that the alarming unit 34 can be used during the power failure.

The analyzer unit 36 is deposed on the top of the elevator car 1 and connected to the alarming unit 34, the intercom 12 and the camera 28. The power of the analyzer unit 36 remains off until the alarming unit 34 turns it on in accordance with the reception of the failure signal from the elevator controller 2. The analyzer unit 36 is configured to collect a sound in the interior of the elevator car 1 and analyzes the collected sound. The analyzer unit 36 is activated for a predetermined period of time to collect and analyzes the sound. In one embodiment, the predetermined period of time is one minute. The sound which includes a passenger's voice is collected via the microphone 24. The analysis of the collected sound is performed by comparing the level of the collected sound with a threshold level. The analyzer unit 36 automatically makes an emergency call to the help desk 26 via the alarming unit 34 and the network 38 when the level of the sound exceeds the threshold level and also gives a command to the camera 28 to take pictures of the interior of the elevator car 1. In other words, the intercom 12 and the camera 28 are triggered by a predetermined sound level in the interior of the elevator car 1. The analyzer unit 36 includes a battery 42 so that the analyzer unit 36 can be used during the power failure.

FIG. 3 is a flowchart showing a procedure for detecting trapped passengers in the elevator car 1. In Step 100, the elevator controller 2 determines whether there is any failure in the elevator system. If the elevator controller 2 does not detect any failure, the flow returns to Step 100. Detecting any failure, the elevator controller 2 outputs a failure signal to the alarming unit 34 in Step 101. In accordance with the reception of the failure signal, the alarming unit 34 makes an alert message, and sends failure information to the help desk 26 in Step 102 and turns on the analyzer unit 36 and the analyzer unit 36 starts collecting a sound in the interior of the elevator car 1 in Step 103.

In Step 104, it is determined whether the alarming unit 34 receives from the elevator controller 2 a restoration signal which indicates the restoration of the elevator system. If the alarming unit 34 receives the restoration signal, the alarming unit 34 turns off the analyzer unit 36 in Step 105 and the flow is terminated. If the alarming unit 34 does not receive the restoration signal, the flow moves to Step 106.

In Step 106, the analyzer unit 36 compares the level of the collected sound with a threshold level. If the level of the sound does not exceed the threshold level, the flow moves to Step 107 and the analyzer unit 36 determines whether a predetermined period of time is elapsed. If the predetermined period of time is not elapsed, the flow returns to Step 104. If it is elapsed, the flow returns to Step 105.

In Step 106, if the level of the sound exceeds the threshold level, the analyzer unit 36 automatically makes an emergency call to the help desk 26 in Step 108. Simultaneously, the analyzer unit 36 gives a command to the camera 28 to take pictures of the interior of the elevator car 1 in Step 109 and outputs picture images to the help desk 26 via the alarming unit 34 and the network 38 in Step 110.

In Step 111, an operator in the help desk 26 determines whether there is a trapped passenger in the elevator car 1 by checking the picture images and/or the sound transmitted through the intercom 12. If no passenger is trapped in the elevator car 1, the flow is terminated. If there is a trapped passenger in the elevator car 1, the operator talks to the trapped passenger in Step 112 and performs necessary procedures. Then, in Step 113, the alarming unit 34 turns off the analyzer unit 36 and the flow is terminated.

According to one embodiment of the invention, the trapped passenger can talk to an operator in the help desk 26 without pressing the emergency button 14. Accordingly, even trapped passengers who cannot reach the emergency button 14 can make an emergency call to the help desk 26 and the existence of such passengers can be noticed by the operator.

While the present invention has been particularly shown and described with reference to the exemplary embodiment as illustrated in the drawings, it will be recognized by those skilled in the art that various modifications may be made without departing from the spirit and scope of the invention as disclosed in the accompanying claims. For example, the trapped passenger is illustrated as a small child in drawings; however, the trapped passenger may be one who uses a wheelchair or a pet such as a dog. Further, in another embodiment, the analyzer unit 36 may either make an emergency call to the help desk 26, or give a command to the camera 28 to take pictures of the interior of the elevator car 1 and output picture images to the help desk 26 if the level of the sound exceeds the threshold level.

What is claimed is:

1. A method for detecting trapped passengers in an elevator car comprising:
collecting a sound in the interior of the elevator car when any failure of an elevator is detected;
comparing the level of the sound with a threshold level; and
determining that there is a trapped passenger in the elevator car when the level of the sound exceeds the threshold level.

2. The method of claim 1 further comprising automatically making a call to a help desk when the level of the sound exceeds the threshold level.

3. The method of claim 1 further comprising taking pictures of the interior of the elevator car and outputting picture images to the help desk.

4. An elevator system comprising:
an elevator controller controlling the movement of an elevator car and detecting a failure of an elevator;
an alarming unit providing a communication network between an elevator car and a help desk remote from the elevator, and receiving a failure signal output from the elevator controller; and
an analyzer unit collecting a sound in the interior of the elevator car, comparing the level of the sound with a threshold level and outputting a result to the alarming unit.

5. The system of claim 4 wherein the analyzer unit automatically makes a call to a help desk when the level of the sound exceeds the threshold level.

6. The system of claim 4 further comprising a camera provided within an elevator car and wherein the camera takes pictures of the interior of the elevator car when the level of the sound exceeds the threshold level.

7. The system of claim 4 further comprising an intercom through which the sound in the interior of the elevator car is collected.
